(19) United States
(12) Patent Application Publication
(10) Pub. No.: US 2026/0100979 A1
(43) Pub. Date: Apr. 9, 2026

(54) PERSONALIZED LIVE AND REAL-TIME MEDIA STREAMING

(71) Applicant: Phenix Real Time Solutions, Inc., Chicago, IL (US)

(72) Inventors: Fabián E. Bustamante, Evanston, IL (US); Stefan Birrer, Chicago, IL (US)

(21) Appl. No.: 18/975,782

(22) Filed: Dec. 10, 2024

Related U.S. Application Data
(60) Provisional application No. 63/704,190, filed on Oct. 7, 2024.

(51) Int. Cl. H04L 65/80; H04L 65/65

(52) U.S. Cl. CPC H04L 65/80; H04L 65/65

(57) ABSTRACT

The disclosed technology incorporates an in-situ-trained, personalized quality of experience model that utilizes contextual information from additional sensors to input into an adaptive bit rate method for live and real-time broadcasting. By being personalized, it adjusts to individual user variations. The in-situ training enables the technology to consider contextual data, allowing it to adapt to both current and anticipated future situations of any user. One aspect of this technology involves a system designed specifically to implement the described techniques within a streaming architecture.

### CROSS-REFERENCE TO RELATED APPLICATIONS

This application claims the priority to and benefit of the U.S. Provisional Patent Application Ser. No. 63/704,190 filed on Oct. 7, 2024, which is incorporated herein in its entirety by this reference.

### TECHNICAL FIELD

The present invention relates to live or real-time media streaming.

### BACKGROUND

Media streaming has become a major source of application traffic on the Internet. In a typical streaming service, video and/or audio data is transmitted as sequential packets from a group of servers to devices used by various users, allowing playback. These services usually offer different versions of the same streams, such as real-time, live, and Video on Demand (VoD) or archived content. Live media streaming refers to transmitting content over the Internet in real time without prior recording or storage. Conversely, VoD streaming involves delivering pre-recorded media from one or more servers to users at any time, without the immediate timing constraints of live streaming.

### SUMMARY

The disclosed technology details a personalized, in-situ-trained, and dynamic Quality of Experience (QoE) model along with a set of associated techniques that utilize contextual data from sensors in the user's device for input into an adaptive bit rate method for real-time streaming. Its personalized nature allows it to cater to all users; its in-situ training enables it to incorporate contextual information; and its dynamic quality permits adaptation to the present conditions. A system is outlined for applying these described techniques within a streaming framework.

### BRIEF DESCRIPTION OF THE DRAWINGS

Detailed descriptions of implementations of the present invention will be described and explained through the use of the accompanying drawings.

FIG. 1 illustrates the Web Real-Time Communications (WebRTC) system architecture without a Quality of Experience (QoE) model.

FIG. 2 illustrates multi-bit rate (MBR) encoding schemes including standard definition (SD), low definition (LD), and super-high definition (SDH).

FIG. 3 illustrates chunk-based and stream content with keyframes and prediction frames.

FIG. 4A illustrates adaptive bit rate streaming for live broadcasting with multiple subscribers.

FIG. 4B illustrates adaptive bit rate streaming for live broadcasting in dynamic network conditions.

FIG. 5 illustrates the WebRTC system architecture including the QoE model.

FIG. 6 illustrates a flowchart of a method performed by a system including the QoE model.

FIG. 7 shows a system to determine a bit rate associated with streaming video.

FIG. 8 is a flowchart of a method to determine a bit rate of a streaming video.

FIG. 9 is a block diagram that illustrates an example of a processing system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The technology detailed here involves a personalized, context-aware, and dynamic Quality of Experience (QoE) model for live and real-time media streaming. This system utilizes contextual information from various sensors on a user's device, such as accelerometers, gyroscopes, ambient light sensors, and microphones, to deduce the user's current surroundings, activity and potential future states. This contextual data directs an adaptive bit rate (ABR) streaming method, which adjusts video quality in real time based on user conditions and preferences.

A feature of this technology includes a system architecture with three primary components. The first is the context-sensing module, configured for collecting sensor data to infer the user's context. The second is the personalized QoE engine, which continuously learns and modifies the QoE model using user interactions and environmental changes. The third component is the ABR adaptation layer, which modifies media quality according to outputs from the personalized QoE engine and integrates with adaptive streaming protocols such as Dynamic Adaptive Streaming over HTTP (DASH) or WebRTC (Web Real-Time Communications), the industry-standard platform for web-based real-time streaming applications.

The technology can enhance user experience by providing immediate responsiveness to changing conditions, such as network bandwidth variations and shifts in the user's physical environment or behavior. It offers a customized streaming experience that adapts to individual user contexts and needs, thereby improving overall engagement and satisfaction.

As used herein, a “model” can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes clustering, reinforcement learning, probability distributions, decision tree forests, and others. Models can be configured for various situations, data types, sources, and output formats.

In some implementations, the personalized QoE model can be a neural network with multiple input nodes that receive sensor data from a user's device, including accelerometers, gyroscopes, ambient light sensors, microphones, and potentially other sensors, like barometers. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer (“the output layer”), one or more nodes can produce a value classifying the input that, once the model is trained, can be used as an indicator for adjusting media quality in real time. In some implementations, such neural networks, known as deep neural networks, can have multiple layers of intermediate nodes with different configurations, can be a combination of models that receive different parts of the input and/or input from other parts of the deep neural network, or are convolutions—partially using output from previous iterations of applying the model as further input to produce results for the current input.

A machine learning model can be trained with supervised learning, where the training data includes sensor data and corresponding user context or environmental conditions as input and a desired output, such as the optimal media quality settings. A representation of the sensor data can be provided to the model. Output from the model can be compared to the desired output for that context, and based on the comparison, the model can be modified, such as by changing weights between nodes of the neural network or parameters of the functions used at each node in the neural network (e.g., applying a loss function). After applying each of the sensor data samples in the training data and modifying the model in this manner, the model can be trained to evaluate new sensor data inputs and adjust media quality accordingly.

Live media streaming services usually tolerate stream lag, which is the delay between an event occurring and its delivery to viewers. These services utilize large buffers to gather packets before playback starts, accommodating this delay. For example, Apple's HTTP Live Streaming (HLS) often experiences several seconds of lag, which is generally acceptable. Conversely, real-time media streaming involves simultaneously recording and broadcasting content with latencies low enough to facilitate “natural” interaction among participants. The minimal lags in these services allow users to respond to or interact with both the content and other participants in real time. This approach prioritizes user interactivity instead of defining specific latency thresholds (e.g., under 0.5 seconds).

A media stream consists of a series of keyframes (also called intra-frames in VP8 or keyframes in MPEG) and prediction frames (known as inter-frames in VP8 and P-frames in MPEG terminology). Keyframes are decoded independently without referencing any other frames; the decoder reconstructs these frames starting from its “default” state. Keyframes serve as points of random access, allowing for video stream seeking. Prediction frames, however, are encoded relative to preceding frames, specifically all prior frames up to and including the latest keyframe. Typically, accurate decoding of a predictive frame relies on the correct decoding of the most recent keyframe and all subsequent predictive frames. Consequently, the decoding algorithm is vulnerable to missing keyframes: In environments where frames may be dropped or corrupted, accurate decoding will only be possible when a keyframe is correctly received.

The effectiveness of video compression largely stems from exploiting inter-frame dependencies. However, these dependencies increase vulnerability to packet loss and limit random access capabilities. Generally, accurate decoding of a predictive frame requires the successful decoding of the latest keyframe and all subsequent predictive frames. Thus, keyframes are critical for random access, enabling seeking within a video stream.

Relatedly, a decoding algorithm cannot tolerate dropped keyframes since prediction frames are encoded in reference to prior frames, specifically all previous frames up to and including the most recent keyframe. In environments where frames may be dropped or corrupted, correct decoding is feasible only once a keyframe is successfully received.

Technologies commonly used for live streaming encompass Microsoft Smooth-Streaming, Apple's HLS, and Adobe's HDS. These protocols are collectively standardized under DASH. Within a DASH framework, each video stream consists of multiple segments (each representing a few seconds) encoded at various discrete bit rates.

For real-time streaming, prevalent technologies include Real-Time Messaging Protocol (RTMP)—a Transmission Control Protocol (TCP)-based protocol initially designed for communication between a flash player and a server—and WebRTC, which typically utilizes Real-Time Transport Protocol (RTP) and Real-time Transport Control Protocol (RTCP) to transmit video frames and control information packets.

In decoding algorithms, dropped keyframes pose significant issues because predictive frames reference all preceding frames up to and including the latest keyframe. Correct decoding, therefore, requires accurate receipt of keyframes, particularly in environments prone to frame loss or corruption.

Delivering a high QoE for video users necessitates balancing two competing demands. Users prefer watching the highest-quality version of a video, where quality is often determined by the video's bit rate. However, the bit rates at which users can view videos are limited by the bandwidth of the network connection between their device and the video server. Attempting to stream at a bit rate exceeding the available network bandwidth results in rebuffering events, which are a critical factor in determining QoE.

### Terminology and Concepts

The terminology used in this document is solely for describing the embodiments and does not restrict the scope of the disclosure. Where applicable, singular terms may encompass their plural counterparts and vice versa.

Unless otherwise specified, terms such as “processing,” “computing,” “calculating,” “determining,” “displaying,” “generating,” and similar references pertain to actions performed by a computer or equivalent electronic computing device that manipulates and transforms data represented as physical (electronic) quantities within the memory or registers into other data also represented as physical quantities within the memory or registers, or other storage, transmission, or display devices.

As used here, terms like “connected,” “coupled,” or similar expressions can denote any form of direct or indirect linkage between two or more elements. The connection or coupling between the elements may be physical, logical, or a blend of both.

References to “an embodiment” or “one embodiment” signify that the particular feature, function, structure, or characteristic under discussion is included in at least one embodiment. Such phrases do not necessarily refer to the same embodiment or imply that alternative embodiments are mutually exclusive.

Unless otherwise specified by context, “comprise” and “comprising” are to be interpreted inclusively (i.e., “including but not limited to”). Similarly, “based on” should be understood inclusively, meaning “based at least in part on.”

The term “module” broadly encompasses software components, hardware components, and/or firmware components. Typically, modules are functional units that generate useful data or outputs based on given inputs. A module can be self-sufficient, and a computer program might consist of multiple modules, each handling different tasks, or a single module performing various functions.

When referring to a list of multiple items, “or” is intended to cover any single item, all items, or any combination of items in the list.

The sequences of steps in any described processes are exemplary; unless physically impossible, steps may be conducted in various orders and combinations. For instance, steps could be added, omitted, reordered, or replaced as necessary.

“Live media streaming” refers to content streamed over the Internet without prior recording or storage. This includes broadcasting content generated by a source device, transmitted through a network, and rendered by a receiving device. Tolerances for stream lag are generally high, with delays of several seconds being common and acceptable, such as in Apple's HLS.

“Real-time media streaming” involves the simultaneous recording and broadcasting of media, allowing participants to interact naturally due to minimal latency. Examples of negligible latency include 100 ms, 300 ms, or 500 ms. This definition supports real-time interactivity among users, enabling them to respond or interact with live content effectively.

Real-time streaming permits participants to engage with content immediately, influencing actions within the stream. For example, audience members could interact with performers in a stand-up comedy show or place bets during a live card game.

To facilitate real-time streaming, a streaming server generates a media stream and transmits it to client devices over a network. A codec compresses the media, and a transport protocol conveys the encoded media. Examples include AVC H.264, H.265, VP8, VP9 for compression and RTSP/RTP, RTMP, and Apple HLS for transport. Before inserting an ad or content element into a media stream, it needs transcoding to an appropriate format (e.g., H.264) suitable for the client's device.

A media stream typically contains key frames (for complete frame rendering) and predictive frames (differential frames referencing key frames). The bit rate defines the video quality, where higher bit rates indicate greater detail. Client devices use key frames to render initial media and subsequent prediction frames for continuous playback. Formats like VP8 and MPEG protocols make use of intra-frames and inter-frames or key frames and P-frames, respectively.

In environments prone to frame drops or corruption, correct decoding relies on proper reception and decoding of key frames. For instance, RTP handles real-time audio and video transmission, utilizing sequence numbers and timestamps for packet order and timing. Delivered via UDP, RTP ensures low latency ideal for real-time communication. RTCP complements RTP by providing feedback on service quality, transmitting periodic packets to monitor conditions like packet loss.

WebRTC, relying on RTP, is the standard for web-based, real-time streaming applications. WebRTC employs buffers to generate video frames from received RTP packets and uses RTCP for sender feedback to potentially adjust encoding rates.

ISO-BMFF/MPEG4 offers a flexible file structure for time-based multimedia management. Media Source Extensions (MSE) allow JavaScript to stream media codecs within browsers, supporting adaptive bit rate streams and closed captions. Encrypted Media Extensions (EME) enable HTML5-based DRM by extending MSE with APIs for protected content playback, incorporating a CDM.

Common Encryption Scheme (CENC) standardizes encryption and key mapping, facilitating interoperability across different DRM systems. CENC ensures multi-DRM support critical for video producers, as most devices support only one type of DRM.

### Using Contextual Information During Real-Time Broadcasting

The technology disclosed relies on two primary insights. First, current real-time video streaming systems utilize ABR guided by a QoE model crafted for an average user presumed to be in a consistently optimal context. This model is considered universal, remaining static over time and unaffected by specific contexts.

However, individual users exhibit different perceptual sensitivities, preferences, and immediate needs. For example, a musician may perceive subtle audio quality changes more distinctly compared to a sports enthusiast, who might be particularly sensitive to video interruptions during a key game moment. Additionally, the same user's sensitivity to quality variations can differ depending on whether they are commuting, cycling home, or relaxing at home.

Second, modern user devices, including handheld mobile devices, are equipped with numerous sensors—such as multiple cameras and microphones, accelerometers, g-sensors, ambient light sensors, proximity sensors, gyroscopes, barometers, and temperature sensors—that can be used to detect the user's context and any changes therein.

The disclosed technology thus introduces techniques for an in-situ-trained, personalized, and dynamic QoE model that leverages contextual information from various sensors in the user's device to inform an adaptive bit rate approach for real-time streaming.

For explanatory purposes, numerous details are provided to ensure a comprehensive understanding of the embodiments of the inventions. However, one skilled in the art will recognize that the embodiments may be practiced without these specific details or with equivalent configurations. In some instances, well-known structures and devices are depicted in block diagram form to avoid unnecessarily obscuring the embodiments.

Referencing the figures, the technology is shown being implemented in a suitable computing and networking environment. It is understood by those skilled in the art that the invention can be practiced with other computer system configurations.

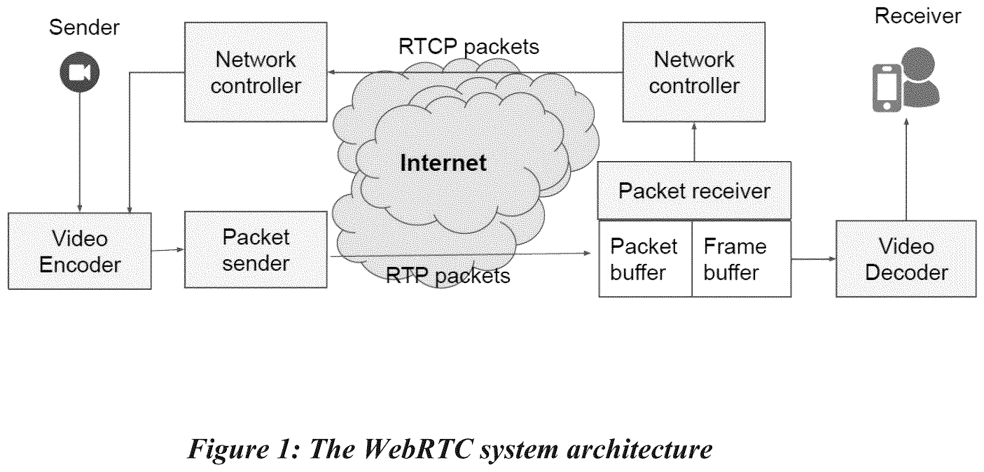

FIG. 1 illustrates an architecture of a WebRTC system. WebRTC serves as the standard platform for real-time streaming applications on the web. It employs the RTP protocol for audio and video transport. The WebRTC framework comprises three primary components: the sender, the network controller, and the receiver. The sender encodes video at a rate suggested by the network controller. These video frames are transmitted as RTP packets to the receiver, which processes them, generates video frames, and provides feedback on loss and delay to the sender via RTCP packets. The network controller then utilizes these reports to fine-tune the sender's encoding rate. Network controllers leverage congestion control algorithms like Google Congestion Control (GCC) to assess network conditions.

WebRTC ensures a baseline set of codecs that all compliant browsers must support, including H.264 and VP8 for video and Opus and G.911 for audio. Streams encoded in formats such as H.264 or Opus, intended for RTP transmission, are unsuitable for DRM encryption/decryption, which requires ISO-BMFF. Conversely, ISO-BMFF streams cannot be directly transmitted over RTP.

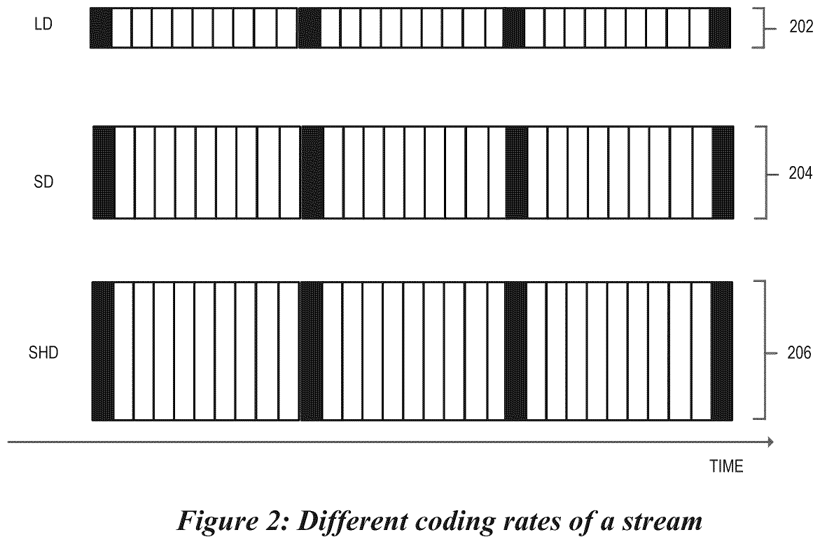

FIG. 2 illustrates an encoded media stream with a set of distribution layers, in accordance with various embodiments. An encoded media stream may include multiple alternative streams LD, SD, SHD, referred to as “distribution layers.” As shown in FIG. 2, an encoded media stream may be streamed over multiple bit rates 202, 204, 206 (or “multi-bit rate (MBR) encoding”). The bit rate of a distribution layer may represent the number of bits for a frame of video, where a greater bit rate correlates to a higher definition video. For example, as shown in FIG. 2, a first distribution layer LD may include a low-definition bit rate 202, a second distribution layer SD may include a standard definition bit rate 204, and a third distribution layer SHD may include a super-high-definition bit rate 206. State-of-the-art media streaming systems rely on MBR encoding, where the source video content is encoded in alternative bitstreams at different coding rates. The content is then streamed directly or in segments or chunks at varying levels of quality corresponding to different coding rates based on changing network conditions. Specifically, the source content is encoded at multiple bit rates and potentially segmented into small multi-second parts.

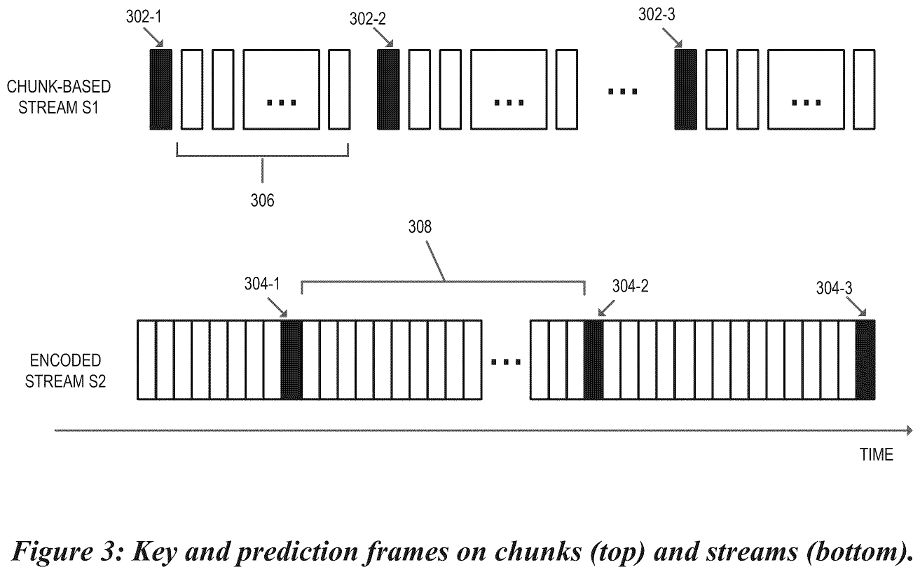

FIG. 3 illustrates the chunk-based or stream content with keyframes and prediction frames. The encoded media stream (e.g., chunk-based stream S1, encoded stream S2) may include data representing media content (e.g., a live video stream).

An encoded media stream may include a series of key frames (e.g., key frames 302-1, 302-2, 302-3, 304-1, 304-2, 304-3) and subsequent prediction frames (e.g., set of prediction frames 306, 308). A key frame (e.g., first key frame 302-1) may represent a full frame of the image in a video. Key frames may be similar to intra-frames in VP8 or key frames in MPEG.

In operation, a client device can process a first key frame 302-1, 304-1 to render the corresponding media content, such as a frame of a video. Key frames may be decoded without reference to any other frame in a sequence, where the decoder reconstructs such frames beginning from the decoder's “default” state. In some embodiments, key frames may provide random access (or seeking) points in a video stream.

The encoded media stream may also include a plurality of prediction frames 306, 308 (also referred to as “delta frames”) succeeding the key frame with respect to time. Prediction frames 306 and 308 may represent the differences between the key frame, which may lower the required data to render the frame represented by the predicted frame. As an example, prediction frames 306 and 308 may be similar to inter-frames in VP8 or P-frames in MPEG terminology. Prediction frames 306 and 308 may be encoded with reference to prior frames and, in some embodiments, all prior frames may be encoded up to and including the most recent key frame. In many cases, the correct decoding of a predictive frame 306 and 308 depends on the correct decoding of the most recent key frame and all ensuing predictive frames. Consequently, the decoding algorithm may not be tolerant of dropped key frames. In an environment in which frames may be dropped or corrupted, correct decoding may not be possible until a key frame is correctly received.

A media stream can be encoded using an encoding technique, such as chunked transfer encoding to create chunks (e.g., divided and non-overlapping portions of the media stream). Chunk-based stream S1 in FIG. 3 may represent an example of a chunk-based stream. Chunks of an encoded media stream may be transmitted and received independently of one another. In some embodiments, both the recipient and the sender of the chunk-based stream may not need to know of the data stream outside of the chunk currently being processed.

Adaptive streaming is based on an ABR algorithm designed to deliver video efficiently to a wide range of devices. In ABR streaming, MBR renditions of the same source—tracks—are created using the transcoder. The channel between server and each individual client player is then established to send one of the tracks; in the ABR mode, the server decides which track to send depending on the user's current network speed. When necessary, manual track selection can be provided in the client player.

ABR adjusts the video playback to maximize QoE, given the potentially changing characteristics of the device and the network. The streaming client is made aware of the available streams at different bit rates and (if necessary) segments of the streams by a manifest file. When a user plays a video, the player subscribes to (requests) a bit rate that is appropriate for the available bandwidth. If the available bandwidth drops, the player can move to a lower-resolution version to avoid rebuffering. If more bandwidth becomes available, the player can switch back to a higher bit rate for a better user experience.

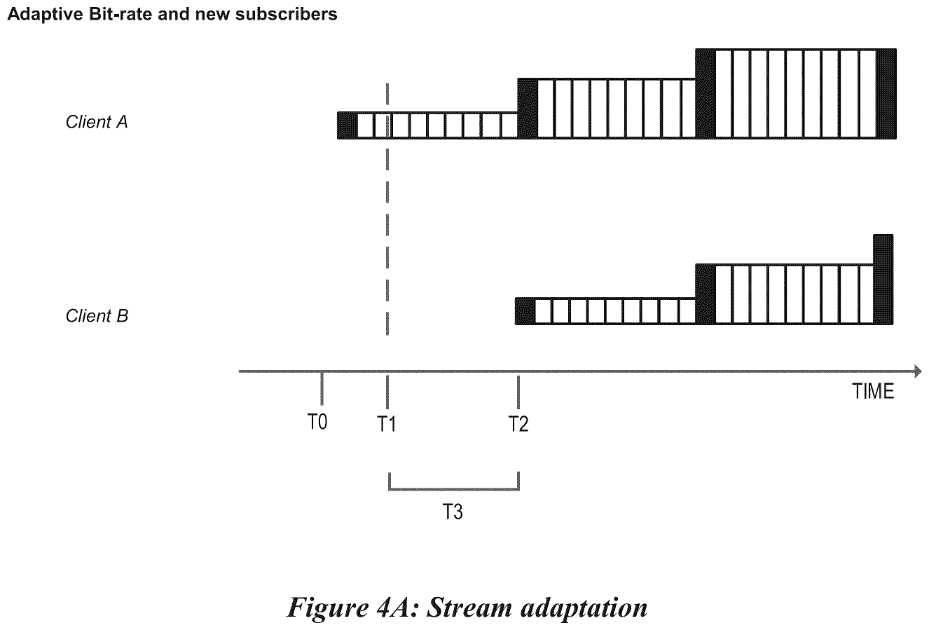

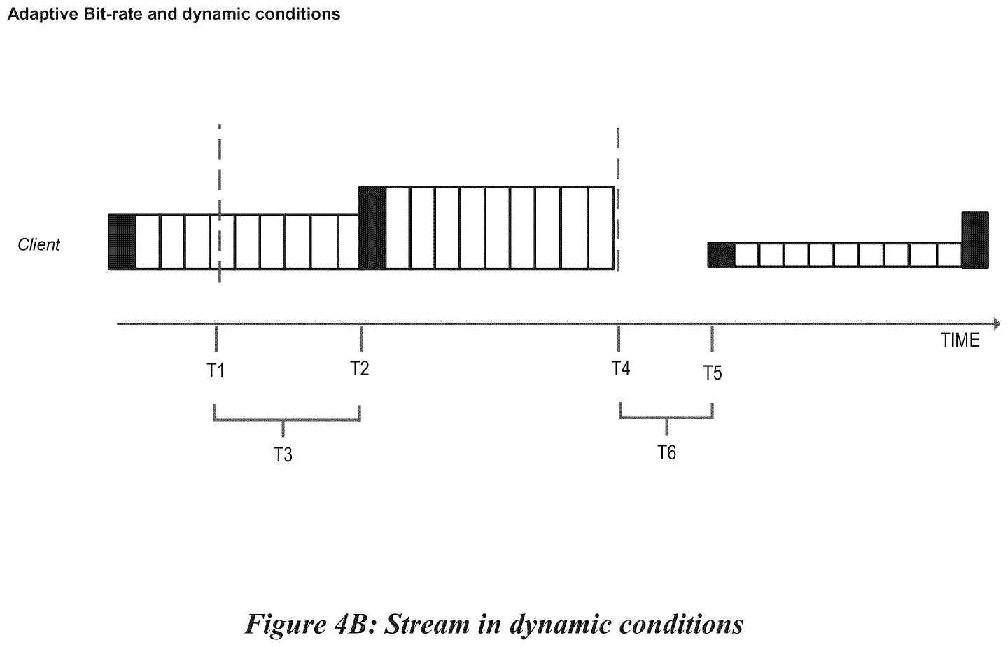

FIG. 4A illustrates an adaptive bit rate streaming for live broadcasting with multiple subscribers. As shown, multiple subscribers (e.g., Client A (subscriber 1), Client B (subscriber 2)) can subscribe to an encoded media stream. As an example, Client A can subscribe to the encoded media stream at time T0. Client B may subscribe at time T1. In some embodiments, if the encoded media stream utilizes adaptive bit rate streaming, each distribution layer of the stream may previously be encoded. However, with live broadcasting, a new client (e.g., Client B) subscribing to the already broadcasting encoded media stream requests a new key frame at a specific resolution (e.g., a distribution layer of the stream associated with the specific resolution). In many cases, the new Client B can request the encoded media stream at a subscription time before the arrival of a new key frame at time T2 in relation to the time domain. The period between the subscription time of the new client T1 and the time where the first frame is rendered T2 may include the startup latency T3.

FIG. 4B illustrates adaptive bit rate streaming for live broadcasting in dynamic network conditions. In some embodiments, in response to changing network conditions, a client may request changing the bit rate of an encoded media stream to adapt to the changing network conditions. For example, as shown in FIG. 4B, the client can determine that a higher bandwidth is available at a first time T1. Determining that a higher bandwidth is available may include the client identifying that available bandwidth can accommodate processing a higher bit rate encoded media stream. Accordingly, the client can request to subscribe to a distribution layer with a higher bit rate to increase the quality of the representative media.

However, to subscribe to a distribution layer with a greater bit rate, the client may have to wait until a new key frame for the requested distribution layer arrives at time T2. Accordingly, the duration between the first time T1 and time T2 represents a time duration where bandwidth is underutilized T3. This wait time T3 (or “time to first frame”) with underutilized bandwidth may result in lower quality of client experience, as the bit rate of the decoded media is at a lower quality than the quality resulting from the higher bit rate stream.

Additionally, as shown in FIG. 4B, the client can incur a bandwidth drop at time T4. A bandwidth drop may include the available bandwidth lowering, where a client may be unable to process the encoded media stream at a present bit rate. In this example, the client can request a lower bit rate stream, and a new key frame at the lower bit rate may arrive at a later time (e.g., first key frame time T5). The time duration from the bandwidth drop-time T4 and the time of the new key frame T5 may be a render discontinuity time duration T6. During the render discontinuity time, the resulting media may be interrupted/glitching or unable to display the media, adaptive bit rate, and dynamic conditions.

The disclosed technology is grounded in two fundamental insights. Firstly, existing real-time video streaming platforms determine ABR using a QoE model designed for an average user, assuming ideal and stable conditions. This implies that the traditional QoE model is regarded as universal, constant over time, and independent of context.

In contrast, the present technology introduces a personalized and dynamic QoE model that leverages sensor-derived contextual information to steer ABR streaming methods in real-time and live-broadcasting scenarios. Unlike conventional systems relying on a static QoE model based on broad assumptions about user preferences and network environments, this innovation facilitates real-time adjustments tailored to individual user contexts, thereby enhancing user experience and engagement.

The QoE model's personalization is achieved through in-situ training, continuously learning from the current user's interactions and contextual data. This encompasses environmental and physiological data gathered from various sensors such as accelerometers, gyroscopes, ambient light sensors, and microphones available on modern devices. This dynamic and user-specific contextual data plays a crucial role in informing adaptive bit rate decisions.

### System Architecture

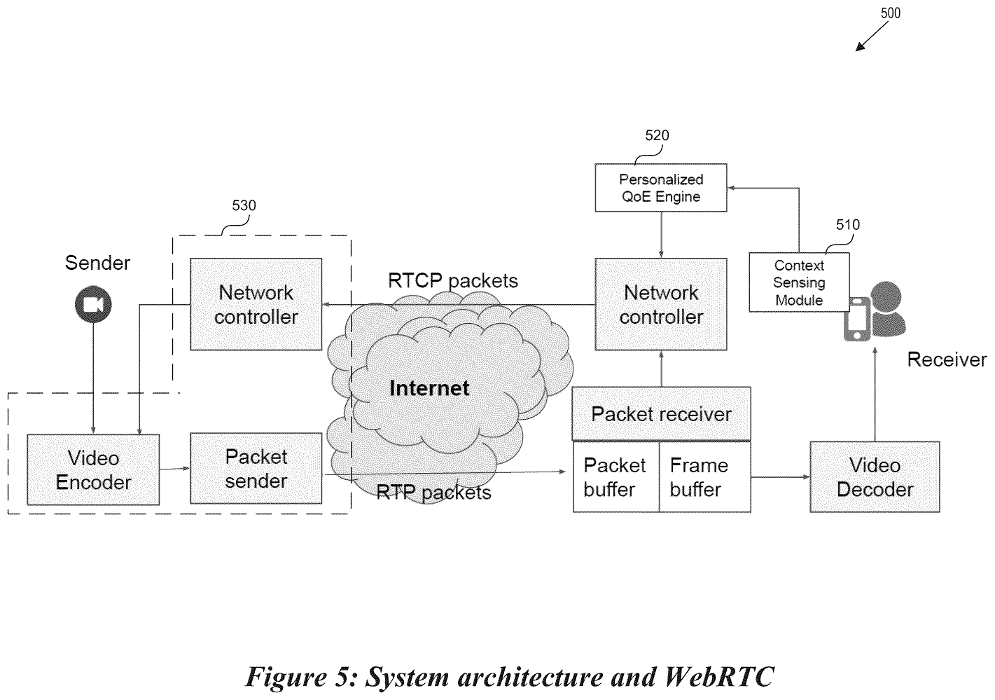

FIG. 5 illustrates a system architecture incorporating the QoE model. The described technology's system architecture 500 can be segmented into three principal components: (1) the context-sensing module 510, (2) the personalized QoE engine 520, and (3) the ABR adaptation layer 530, as shown in FIG. 5.

The context-sensing module 510 component collects data from sensors available on the user's device. The contextual information can encompass motion data (from accelerometers and gyroscopes), lighting conditions (from light sensors), sound levels (from microphones), and network metrics like signal strength and latency. This module uses the gathered data to deduce the user's current environment and predict potential future states, such as whether the user is stationary, moving, or in a noisy setting.

The personalized QoE engine 520 is central to the system architecture 500 because it dynamically adjusts the QoE model based on real-time training. The engine processes contextual details and learns user preferences over time through machine learning algorithms. It continuously refines the model to represent the user's real-time conditions, preferences, and feedback. This engine not only predicts current QoE requirements but also predicts the user's future needs, facilitating preemptive adjustments in bandwidth-limited environments.

The ABR adaptation layer 530 interfaces directly with the media player and streaming protocols, like DASH or WebRTC, to dynamically adjust the bit rate. Unlike conventional ABR algorithms that depend solely on network bandwidth estimations, this adaptation layer utilizes the outputs from the personalized QoE engine 520 to guide bit rate decisions. For instance, if the user's context suggests limited attention to video quality due to external distractions, the system may lower the video resolution to save bandwidth and reduce latency.

The system architecture 500 ensures that the system remains responsive to evolving conditions, such as varying network bandwidth and changes in the user's physical environment or behavior.

### Adaptive Learning Approach

The QoE model undergoes dynamic training via a feedback loop based on user interactions with media content. Metrics of user satisfaction, including the rate of video rebuffering, bit rate variations, and playback interruptions, are consistently tracked. The system adaptively refines its model to emphasize various aspects of the experience, such as reducing latency or enhancing video clarity, guided by user context and feedback. As user preferences and environments shift, the model evolves correspondingly, ensuring an optimized experience without requiring explicit user intervention.

### Operational Use Case

Consider a user watching live sports on a mobile device during their commute. As the user moves from a noisy subway to a quiet home, the device's sensors track changes in sound and motion levels. The personalized QoE engine 520 then adjusts the bit rate accordingly. On the subway, it might focus on audio clarity and lower video quality to prevent rebuffering. Once at home, it boosts the video bit rate for a higher-resolution stream, improving the overall experience.

### EXAMPLES

In some aspects, the techniques described herein relate to a system for personalizing real-time and live-streaming media experiences by dynamically adapting video bit rates. The system includes a context-sensing module 510 configured to collect sensor data from a user's device, including accelerometers, gyroscopes, ambient light sensors, or microphones; a personalized Quality of Experience (QoE) engine configured to process said sensor data and infer user context, wherein the QoE engine 520 is trained in situ based on user interactions and environmental conditions; and an adaptive bit rate adaptation layer configured to adjust media quality in response to outputs from the personalized QoE engine 520.

In some aspects, the adaptive bit rate adaptation layer is integrated with an adaptive streaming protocol corresponding to DASH or WebRTC. In some aspects, the context-sensing module 510 is configured to collect data related to network conditions, including signal strength and latency. In some aspects, the personalized QoE engine 520 is configured to use machine learning algorithms to dynamically adjust the QoE model based on real-time user feedback.

In some aspects, the adaptive bit rate adaptation layer is configured to prioritize audio clarity over video quality when the user is detected to be in a noisy environment and increase video resolution when the user is detected to be in a stable and quiet environment. In some aspects, the context-sensing module 510 includes a barometer configured to detect changes in altitude, wherein the barometer is used to infer user activity including climbing stairs. In some aspects, the personalized QoE engine 520 is configured to predict future user context based on historical data and current sensor readings. In some aspects, the adaptive bit rate adaptation layer is configured to use a congestion control algorithm to estimate network conditions and adjust the encoding rate accordingly. In some aspects, the personalized QoE engine 520 is capable of operating in both online and offline modes, allowing for continuous QoE optimization even in the absence of network connectivity.

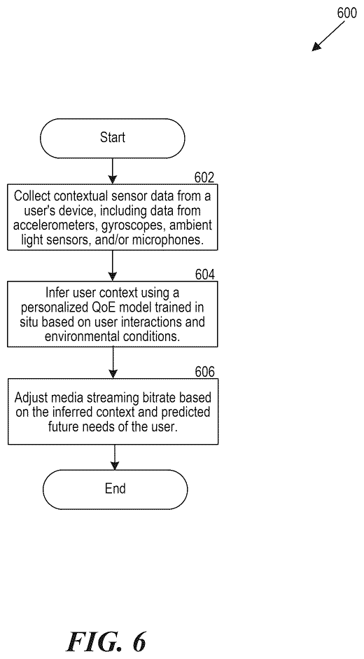

FIG. 6 illustrates a flowchart of a method 600 performed by a system including the QoE model. At 602, the system collects contextual sensor data from a user's device, including data from accelerometers, gyroscopes, ambient light sensors, and/or microphones. At 604, the system infers user context using a personalized QoE model trained in situ based on user interactions and environmental conditions. At 606, the system adjusts the media streaming bit rate based on the inferred context and predicted future needs of the user, wherein the adjustment is performed by an adaptive bit rate adaptation layer integrated with an adaptive streaming protocol such as DASH or WebRTC.

In some aspects, the system preemptively adjusts the bit rate based on predicted future network conditions. In some aspects, the system infers user context including: determining whether the user is stationary, walking, or in a vehicle. In some aspects, the system adjusts media streaming bit rate including: switching between different encoding rates to minimize rebuffering events. In some aspects, the system collects user satisfaction metrics to refine the QoE model, wherein the user satisfaction metrics include a frequency of video rebuffering and playback interruptions. In some aspects, the system periodically updates the personalized QoE model to reflect changes in user preferences and environmental conditions.

In another aspect of the disclosed technology, a non-transitory, computer-readable medium stores instructions that, when executed by a processor, cause the processor to collect contextual sensor data from a user's device, including data from accelerometers, gyroscopes, ambient light sensors, and microphones; infer user context using a personalized QoE model trained in situ based on user interactions and environmental conditions; and adjust media streaming bit rate based on the inferred context and predicted future needs of the user, wherein the adjustment is performed by an adaptive bit rate adaptation layer integrated with an adaptive streaming protocol such as DASH or WebRTC.

In some aspects, the processor collects data related to user interactions with the media content, including play, pause, and seek actions. In some aspects, the processor is further caused to adjust the bit rate based on the user's current physical activity level, inferred from sensor data. In some aspects, the processor is further caused to prioritize minimizing latency during live sports events. In some aspects, the processor is further caused to increase video clarity during video calls when the user is detected to be in a stable environment.

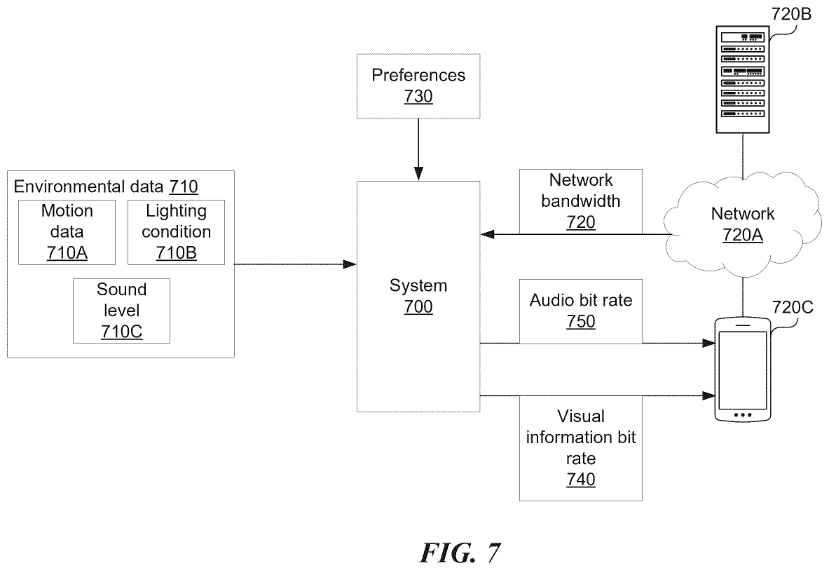

FIG. 7 shows a system to determine a bit rate associated with streaming video. The system 700 obtains environmental data 710 including motion data 710A, lighting condition 710B and a sound level 710C from multiple sensors associated with a receiver device 720C. Multiple sensors can include accelerometers, gyroscopes, light sensors, microphones, etc.

The system 700 can also obtain an indication of network bandwidth 720 associated with a network 720A between a sender device 720B and the receiver device 720C. The sender device 720B can be a cloud server, whether the receiver device 720C can be a personal device such as a personal computer, a phone, a tablet, a watch, augmented reality/virtual reality glasses, etc.

The system 700 can measure network bandwidth using a variety of methods and metrics. The system 700 can directly measure throughput by monitoring actual data transfer rates over time or employ packet pair/train techniques to estimate available bandwidth. Active probing involves sending test data periodically, while passive monitoring analyzes existing traffic patterns. Round-trip time (RTT) measurements and TCP window size monitoring can provide insights into network congestion and available bandwidth. For real-time communications, RTCP feedback offers transmission quality metrics. The system can also utilize congestion control algorithms like Google Congestion Control (GCC) in WebRTC to estimate network conditions. In streaming applications, adaptive bit rate streaming metrics help gauge how quickly different quality levels of content are downloaded and played back. On mobile devices, signal strength and connection type information can estimate potential bandwidth. Additionally, the system can leverage historical data analysis and network API information provided by some platforms. By combining multiple measurement techniques, the system can obtain a more accurate and robust estimate of the available network bandwidth, enabling better adaptation of the streaming bit rate to optimize the user experience.

The system 700 can obtain an indication of preferences 730 associated with the receiver device 720C. The indication of preferences 730 can indicate a first relationship between visual information quality associated with a streaming video and the motion data, the lighting condition, the sound level, and the indication of network bandwidth. Further, the indication of preferences indicates a second relationship between audio quality associated with the streaming video and the motion data, the lighting condition, the sound level, and the indication of network bandwidth. For example, the indication of preferences 730 can indicate that the user is an audiophile and prefers higher audio quality than video quality, or that the user likes to play video games and prefers higher video quality than audio quality. Alternatively, the indication of preferences 730 can indicate how to adjust the streaming video quality based on, e.g., motion data. For example, if the user is walking, the video can be streamed at high quality, however, if the user is transported by a vehicle, the quality of the video can be lowered.

Based on the environmental data 710, the indication of network bandwidth 720, and the indication of preferences 730 associated with the receiver device 720C, the system 700 determines a first bit rate 740 of visual information associated with the streaming video, and a second bit rate 750 of audio associated with the streaming video. The first and second bit rate can be different. Upon determining the bit rate 740, 750, the system 700 can send the visual information at the first bit rate and the audio information of the second bit rate to the receiver device 720C.

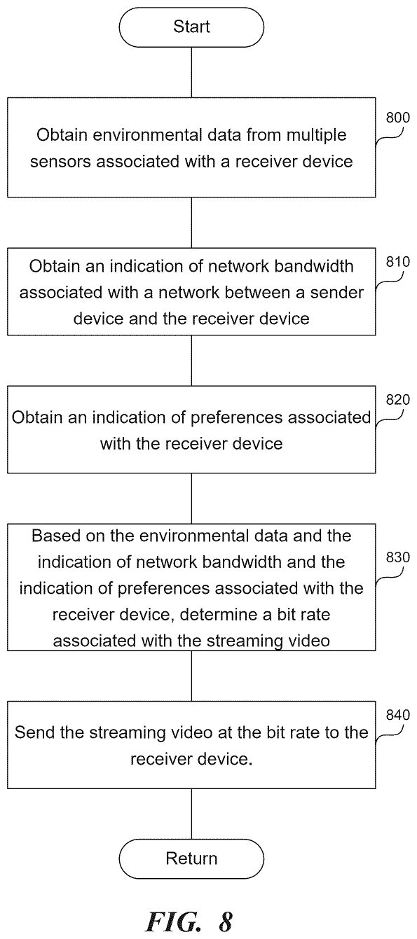

FIG. 8 is a flowchart of a method to determine a bit rate of a streaming video. A hardware or software processor executing instructions described in this application can in step 800 obtain environmental data from multiple sensors associated with a receiver device. The environmental data can include motion data, lighting data, and sound level from the environment surrounding the receiver device.

In step 810, the processor can obtain an indication of network bandwidth associated with a network between a sender device and the receiver device. The processor can use a specialized congestion control algorithm designed for real-time communications in WebRTC. Its primary purpose is to optimize media transmission over varying network conditions by dynamically adjusting the sending bit rate to maximize quality while minimizing latency and packet loss. The congestion algorithm employs a delay-based approach, primarily using packet delay variation to detect congestion, rather than relying solely on packet loss. The congestion algorithm continuously adapts the sending rate based on network feedback and is designed to work well with other TCP flows sharing the network. The congestion algorithm operates on both the sender and receiver sides. On the sender side, the congestion algorithm estimates available bandwidth, adjusts encoding bit rate and packet transmission rate, and responds to feedback from the receiver. The receiver side measures packet arrival times and inter-arrival time variations, sends feedback to the sender via RTCP packets, and provides information on packet loss and estimated bandwidth. This bidirectional feedback loop allows the congestion algorithm to make informed decisions about bit rate adjustments, enabling WebRTC applications to maintain high-quality audio and video streams while adapting to network fluctuations. By employing the congestion algorithm, WebRTC can provide a responsive and adaptive real-time communication experience across a wide range of network conditions.

In step 820, the processor can obtain an indication of preferences associated with the receiver device. The indication of preferences can indicate a first relationship between visual information quality associated with a streaming video and the environmental information such as motion data, the lighting condition, the sound level, and the indication of network bandwidth. For example, the first relationship can indicate that when the network bandwidth is low and environmental information indicates that the user is moving, the preference is to lower the quality of the visual information in the streaming video. Further, the indication of preferences can indicate a second relationship between audio quality associated with the streaming video and the environmental data and the indication of network bandwidth. For example, the second relationship can indicate when the network bandwidth is low, and the environmental information indicates that the environment is noisy, to increase the quality of the audio information in the streaming video.

In step 830, based on the environmental data and the indication of network bandwidth and the indication of preferences associated with the receiver device, the processor can determine a bit rate associated with the streaming video. The bit rate can be broken down into a first bit rate associated with the visual information and a second bit rate associated with the audio. The first and second bit rate can be different.

In step 840, the processor can send the streaming video at the bit rate to the receiver device. Specifically, the processor can send the visual information at the first bit rate to the receiver device and send the audio at the second bit rate to the receiver device. The processor can repeat the above described steps 800-840 continuously because the sensor readings continuously change based on additional information about preferences associated with the receiver device, such as the user stopping the streaming video, providing explicit indication to increase and/or decrees quality of video and/or audio, or the user updating the preferences. Steps 800 and 810 can be performed by a context-sensing module, step 820 can be performed by a QoE engine, and steps 830, 840 can be performed by adaptive bit rate adaptation layer.

The processor can train an artificial intelligence model to provide the indication of preferences associated with the receiver device. The processor can train a QoE engine by performing the following steps. The QoE engine can be an artificial intelligence. First, the processor can obtain multiple metrics of user satisfaction including a rate of video rebuffering, a bit rate variation, and playback interruptions associated with the streaming video. For example, if there is rebuffering or playback interruption, the processor can lower the quality of audio or visual information. Second, the processor can obtain the environmental data from the multiple sensors. Third, the processor can establish a correspondence between the multiple metrics and the environmental data through training the QoE engine. The processor can obtain current environmental data from the multiple sensors and determine, using the QoE engine, a bit rate associated with the streaming video based on the current environmental data from the multiple sensors.

The processor can obtain an initial profile from the user. Prior to determining the first bit rate and the second bit rate, the processor can obtain an indication of a profile associated with a user of the receiver device, where the profile indicates whether the user is an audiophile, whether the user consumes streaming video associated with sports, and whether the user consumes streaming video associated with games. Upon obtaining an indication that the user is the audiophile, the processor can reduce the first bit rate of the visual information associated with the streaming video, prior to reducing the second bit rate of audio associated with the streaming video. Upon obtaining an indication that the user consumes streaming video associated with sports and/or that the user consumes streaming video associated with games, the processor can reduce the second bit rate of audio associated with the streaming video prior to reducing the first bit rate of the visual information associated with the streaming video.

The processor can obtain an indication of an increase in speed associated with the receiver device. Upon obtaining the indication of the increase in speed associated with the receiver device, the processor can decrease the first bit rate of visual information associated with the streaming video. The processor can obtain an indication of an increase in ambient sound associated with the receiver device and, in response, can increase the second bit rate of the audio associated with the streaming video. The processor can obtain an indication of an increase in brightness in an environment associated with the receiver device and, in response, can decrease the first bit rate of visual information associated with the streaming video.

The processor can obtain an indication of an activity in which a user associated with the receiver device is engaged, where the activity includes walking, running, biking, or being transported by a vehicle. The processor can obtain this from an artificial intelligence that categorizes motion data into different activities. The artificial intelligence can be different from the QoE engine. Based on the indication of the activity, the processor can adjust the first bit rate of visual information associated with the streaming video and the second bit rate of the audio associated with the streaming video. For example, if the user is walking, the processor can increase the quality of the visual information and the audio, if the user is running or biking decrease the quality of video but increase quality of audio, or if the user is in a vehicle, the processor can increase quality of both visual information and audio.

The processor can enable the user to override the selected bit rate and to explicitly specify preferences. Subsequently, the processor can use user-specified information to train the QoE engine. Specifically, upon sending the visual information at the first bit rate to the receiver device and sending the audio at the second bit rate to the receiver device, the processor can obtain an indication from the receiver device to adjust the first bit rate and/or the second bit rate. The processor can train a QoE engine based on the indication from the receiver device to adjust the first bit rate and/or the second bit rate and the environmental data from the multiple sensors.

To estimate network bandwidth, the processor can estimate available bandwidth between the sender device and the receiver device and adjust an encoding bit rate and packet transmission rate based on the estimated available bandwidth. The processor can receive feedback from the receiver device via Real-time Transport Control Protocol (RTCP) packets containing information on packet loss and estimated bandwidth. The feedback can be formulated based on packet arrival times, inter-arrival time variations, and packet loss. The processor can dynamically adapt a sending bit rate based on the feedback to optimize media transmission while minimizing latency and packet loss.

### Computer System

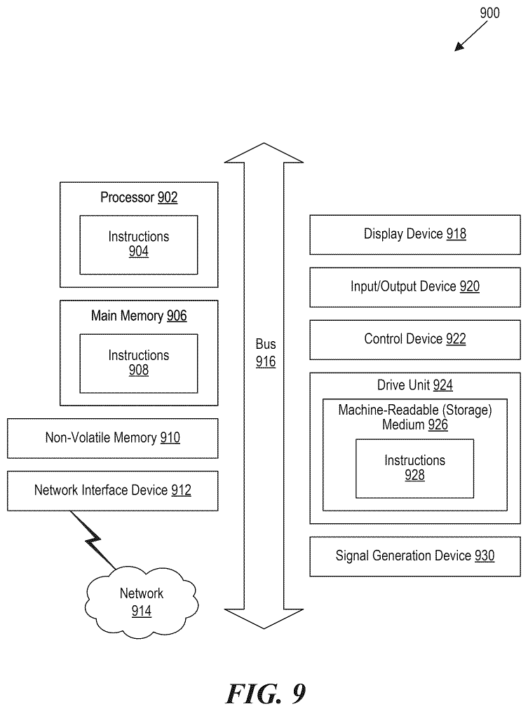

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a video display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the Figures and any other components described in this specification can be implemented.

The computer system 900 can take any suitable physical form. For example, the computing system 900 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 900. In some implementations, the computer system 900 can be an embedded computer system, a system-on-chip (SOC), a single-board computer system (SBC), or a distributed system such as a mesh of computer systems, or it can include one or more cloud components in one or more networks. Where appropriate, one or more computer systems 900 can perform operations in real time, in near real time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computing system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computing system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium comprising instructions recorded there on, wherein the instructions when executed by at least one data processor of a system, cause the system to:
obtain motion data, lighting condition, and a sound level from multiple sensors associated with a receiver device;
obtain an indication of network bandwidth associated with a network between a sender device and the receiver device;
obtain an indication of preferences associated with the receiver device,
wherein the indication of preferences indicates a first relationship between visual information quality associated with a streaming video and the motion data, the lighting condition, the sound level and the indication of network bandwidth, and
wherein the indication of preferences indicates a second relationship between audio quality associated with the streaming video and the motion data, the lighting condition, the sound level and the indication of network bandwidth;
based on the motion data, the lighting condition, the sound level, the indication of network bandwidth and the indication of preferences associated with the receiver device, determine a first bit rate of visual information associated with the streaming video, and a second bit rate of audio associated with the streaming video;
send the visual information at the first bit rate to the receiver device; and
send the audio at the second bit rate to the receiver device.

2. The non-transitory, computer-readable storage medium of claim 1, comprising instructions to:
train a Quality of Experience (QoE) engine by:
obtaining multiple metrics of user satisfaction including a rate of video rebuffering, a bit rate variation, and playback interruptions associated with the streaming video;
obtaining the motion data, the lighting condition, and the sound level from the multiple sensors;
establishing a correspondence between the multiple metrics and the motion data, the lighting condition, and the sound level;
obtain current motion data, current lighting condition, and current sound level from the multiple sensors; and
determine, using the QoE engine, a bit rate associated with the streaming video based on the current motion data, current lighting condition, and current sound level from the multiple sensors.

3. The non-transitory, computer-readable storage medium of claim 1, comprising instructions to:
prior to determining the first bit rate and the second bit rate, obtain an indication of a profile associated with a user of the receiver device,
wherein the profile indicates whether the user is an audiophile, whether the user consumes streaming video associated with sports, and whether the user consumes streaming video associated with games;
upon obtaining an indication that the user is the audiophile, reduce the first bit rate of the visual information associated with the streaming video, prior to reducing the second bit rate of audio associated with the streaming video; and
upon obtaining an indication that the user consumes streaming video associated with sports, and/or that the user consumes streaming video associated with games, reduce the second bit rate of audio associated with the streaming video prior to reducing the first bit rate of the visual information associated with the streaming video.

4. The non-transitory, computer-readable storage medium of claim 1, comprising instructions to:
obtain an indication of an increase in speed associated with the receiver device; and
upon obtaining the indication of the increase in speed associated with the receiver device, decrease the first bit rate of visual information associated with the streaming video; or
obtain an indication of an increase in ambient sound associated with the receiver device; and
upon obtaining the indication of the increase in ambient sound associated with the receiver device, increase the second bit rate of the audio associated with the streaming video; or
obtain an indication of an increase in brightness in an environment associated with the receiver device; and
upon obtaining the indication of increasing brightness in the environment associated with the receiver device, decrease the first bit rate of visual information associated with the streaming video.

5. The non-transitory, computer-readable storage medium of claim 1, comprising instructions to:
obtain an indication of an activity in which a user associated with the receiver device is engaged,
wherein the activity includes walking, running, biking or being transported by a vehicle; and
based on the indication of the activity, adjust the first bit rate of visual information associated with the streaming video and the second bit rate of the audio associated with the streaming video.

6. The non-transitory, computer-readable storage medium of claim 1, comprising instructions to:
upon sending the visual information at the first bit rate to the receiver device and sending the audio at the second bit rate to the receiver device, obtain an indication from the receiver device to adjust the first bit rate and/or the second bit rate; and
train a Quality of Experience (QoE) engine based on the indication from the receiver device to adjust the first bit rate and/or the second bit rate and the motion data, the lighting condition, and the sound level from the multiple sensors.

7. The non-transitory, computer-readable storage medium of claim 1, comprising instructions to:
estimate available bandwidth between the sender device and the receiver device;
adjust an encoding bit rate and packet transmission rate based on the estimated available bandwidth;
receive feedback from the receiver device via Real-time Transport Control Protocol (RTCP) packets containing information on packet loss and estimated bandwidth; and
dynamically adapt a sending bit rate based on the feedback to optimize media transmission while minimizing latency and packet loss.

8. A method comprising:
obtaining environmental data from multiple sensors associated with a receiver device;
obtaining an indication of network bandwidth associated with a network between a sender device and the receiver device;
obtaining an indication of preferences associated with the receiver device,
wherein the indication of preferences indicates a first relationship between visual information quality associated with a streaming video and the environmental data and the indication of network bandwidth, and
wherein the indication of preferences indicates a second relationship between audio quality associated with the streaming video and the environmental data and the indication of network bandwidth;
based on the environmental data and the indication of network bandwidth and the indication of preferences associated with the receiver device, determining a bit rate associated with the streaming video; and
sending the streaming video at the bit rate to the receiver device.

9. The method of claim 8, comprising:
training a Quality of Experience (QoE) engine by:
obtaining multiple metrics of user satisfaction including a rate of video rebuffering, a bit rate variation, and playback interruptions associated with the streaming video;
establishing a correspondence between the multiple metrics and the environmental data;
obtaining current environmental data from the multiple sensors; and
determining, using the QoE engine, the bit rate associated with the streaming video based on the current environmental data from the multiple sensors.

10. The method of claim 8, comprising:
prior to determining the bit rate, obtaining an indication of a profile associated with a user of the receiver device,
wherein the profile indicates whether the user is an audiophile, whether the user consumes streaming video associated with sports, and whether the user consumes streaming video associated with games;
upon obtaining an indication that the user is the audiophile, reducing a first bit rate of visual information associated with the streaming video, prior to reducing a second bit rate of audio associated with the streaming video; and
upon obtaining an indication that the user consumes streaming video associated with sports, and/or that the user consumes streaming video associated with games, reducing the second bit rate of audio associated with the streaming video prior to reducing the first bit rate of the visual information associated with the streaming video.

11. The method of claim 8, comprising:
obtaining an indication of an increase in speed associated with the receiver device; and
upon obtaining the indication of the increase in speed associated with the receiver device, decreasing the bit rate associated with the streaming video; or
obtaining an indication of an increase in ambient sound associated with the receiver device; and
upon obtaining the indication of the increase in ambient sound associated with the receiver device, increasing a second bit rate of audio associated with the streaming video; or
obtaining an indication of an increase in brightness in an environment associated with the receiver device; and
upon obtaining the indication of increasing brightness in the environment associated with the receiver device, decreasing a first bit rate of visual information associated with the streaming video.

12. The method of claim 8, comprising:
obtaining an indication of an activity in which a user associated with the receiver device is engaged,
wherein the activity includes walking, running, biking, or being transported by a vehicle; and
based on the indication of the activity, adjusting the bit rate associated with the streaming video.

13. The method of claim 8, comprising:
upon sending the streaming video at the bit rate to the receiver device, obtaining an indication from the receiver device to adjust the bit rate; and
training a Quality of Experience (QoE) engine based on the indication from the receiver device to adjust the bit rate and the environmental data from the multiple sensors.

14. A system comprising:
a context-sensing module configured to:
obtain environmental data from multiple sensors associated with a receiver device;
obtain an indication of network bandwidth associated with a network between a sender device and the receiver device;
a QoE engine configured to:
obtain an indication of preferences associated with the receiver device,
wherein the indication of preferences indicates a first relationship between visual information quality associated with a streaming video and the environmental data and the indication of network bandwidth, and
wherein the indication of preferences indicates a second relationship between audio quality associated with the streaming video and the environmental data and the indication of network bandwidth;
an adaptive bit rate adaptation layer configured to:
based on the environmental data and the indication of network bandwidth and the indication of preferences associated with the receiver device, determine a bit rate associated with the streaming video; and
send the streaming video at the bit rate to the receiver device.

15. The system of claim 14, comprising:
a processor to train a Quality of Experience (QoE) engine by:
obtaining multiple metrics of user satisfaction including a rate of video rebuffering, a bit rate variation, and playback interruptions associated with the streaming video;
obtaining the environmental data from the multiple sensors;
establishing a correspondence between the multiple metrics and the environmental data;
the QoE engine to:
obtain current environmental data from the multiple sensors; and
determine the bit rate associated with the streaming video based on the current environmental data from the multiple sensors.

16. The system of claim 14, comprising the adaptive bit rate adaptation layer configured to:
prior to determining the bit rate, obtain an indication of a profile associated with a user of the receiver device,
wherein the profile indicates whether the user is an audiophile, whether the user consumes streaming video associated with sports, and whether the user consumes streaming video associated with games;
upon obtaining an indication that the user is the audiophile, reduce a first bit rate of visual information associated with the streaming video, prior to reducing a second bit rate of audio associated with the streaming video; and
upon obtaining an indication that the user consumes streaming video associated with sports, and/or that the user consumes streaming video associated with games, reduce the second bit rate of audio associated with the streaming video prior to reducing the first bit rate of the visual information associated with the streaming video.

17. The system of claim 14, comprising the adaptive bit rate adaptation layer configured to:
obtain an indication of an increase in speed associated with the receiver device; and
upon obtaining the indication of the increase in speed associated with the receiver device, decrease the bit rate associated with the streaming video; or
obtain an indication of an increase in ambient sound associated with the receiver device; and
upon obtaining the indication of the increase in ambient sound associated with the receiver device, increase a second bit rate of audio associated with the streaming video; or
obtain an indication of an increase in brightness in an environment associated with the receiver device; and
upon obtaining the indication of increasing brightness in the environment associated with the receiver device, decrease a first bit rate of visual information associated with the streaming video.

18. The system of claim 14, comprising the QoE engine configured to:
obtain an indication of an activity in which a user associated with the receiver device is engaged,
wherein the activity includes walking, running, biking, or being transported by a vehicle; and
based on the indication of the activity, adjust the bit rate associated with the streaming video.

19. The system of claim 14, comprising:
the context-sensing module configured to, upon sending the streaming video at the bit rate to the receiver device, obtain an indication from the receiver device to adjust the bit rate; and
a processor configured to train a Quality of Experience (QoE) engine based on the indication from the receiver device to adjust the bit rate and the environmental data from the multiple sensors.

20. The system of claim 14, comprising the adaptive bit rate adaptation layer configured to:
estimate available bandwidth between the sender device and the receiver device;
adjust an encoding bit rate and packet transmission rate based on the estimated available bandwidth;
receive feedback from the receiver device via Real-time Transport Control Protocol (RTCP) packets containing information on packet loss and estimated bandwidth; and
dynamically adapt a sending bit rate based on the feedback to optimize media transmission while minimizing latency and packet loss.
